(19) United States
(12) Patent Application Publication
(10) Pub. No.: US 2006/0201282 A1
(43) Pub. Date: Sep. 14, 2006

(54) Torque adjustable socket assembly

(76) Inventor: Chang Chuan Lee, Nantou (TW)

Correspondence Address: LEE, CHANG CHUAN, P.O. BOX 403, TAICHUNG, TW

(21) Appl. No.: 11/362,068

(22) Filed: Feb. 27, 2006

(30) Foreign Application Priority Data
Mar. 9, 2005 (TW) 094203647

(51) Int. Cl. B25B 13/46

(52) U.S. Cl. 81/58.3

(57) ABSTRACT

A socket assembly includes a first part and a second part which is engaged with the first part by two respective toothed surfaces defined in two respective ends of the two parts. A sleeve is mounted to the first and second pasts and the other end of the first part extends through the sleeve so as to be connected with a ratchet tool. The other end of the second part is stopped on a stop extending from an inner periphery of the sleeve. A cover is threadedly connected to the outer periphery of the sleeve so as to compress a biasing member mounted on the first part. The biasing member pushes the first part toward the second part. The torque can be set by rotating the cover and the value of the torque can be read by the markings on the sleeve.

### FIELD OF THE INVENTION

The present invention relates to a socket which includes two parts engaged by two perspective toothed surfaces and a biasing member compresses one part to the other so that when the desired torque is reached the two parts are separated.

### BACKGROUND OF THE INVENTION

A conventional socket 7 is shown in FIG. 1 and generally includes a first section 71 and a second section 72, wherein the first section 71 includes a first recess for receiving a driving head of a ratchet tool 9, and a second recess is defined in the second section 72 so that a head of a bolt 8 is engaged with the second recess. When rotating the ratchet tool 9, the whole socket 7 is rotated so that the bolt 8 can be tightened or loosened. The bolt 8 is applied by a torque that is generated by the rotation of the ratchet tool 9 by the user. The user cannot control the exact value of the torque applied to the bolt 8. If the torque is exceed over the designed torque that the bolt 8 is design, the bolt 8 is broken. On the contrary, if the torque is too small, the bolt 8 cannot be well secured to the objects. Vibration of the object can further loosen the bolt 8 which could be separated from the objects. When the objects are subjected to high stress, such as the air-crafts or ships, the loosened bolts 8 might lead to dangerous results.

The present invention intends to provide a socket assembly whose torque can be pre-set and controlled so as to protect the bolts and the objects can be well connected by the bolts.

### SUMMARY OF THE INVENTION

The present invention relates to a socket assembly which comprises a first part having a first toothed surface defined in a first end thereof and a second end of the first part is to be connected with a tool. A second part has a work end at a first end thereof and a second toothed surface defined in a second end of the second part. The first and second toothed surfaces are engaged with each other. A sleeve is mounted to the first and second part and the second end of the first part extends through a first open end of the sleeve. A stop extends from an inner periphery of a second open end of the sleeve so that the work end is stopped on the stop. A plurality of value markings are marked on an outer periphery of the sleeve. A cover is threadedly connected to the outer periphery of the sleeve and a biasing member is mounted on the first part. A first end of the biasing member is rested on a flange of the first part, and a second end of the biasing member is in contact with an inside of the cover.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the socket assembly of the present invention;

FIG. 2 is a cross sectional view of the socket assembly of the present invention;

FIG. 3 shows the first part is connected with a ratchet tool and the second part is connected with a bolt;

FIG. 4 is an exploded view to show another embodiment of the socket assembly of the present invention, and

FIG. 5 shows a ratchet tool is connected to a conventional socket which is mounted on a head of a bolt.

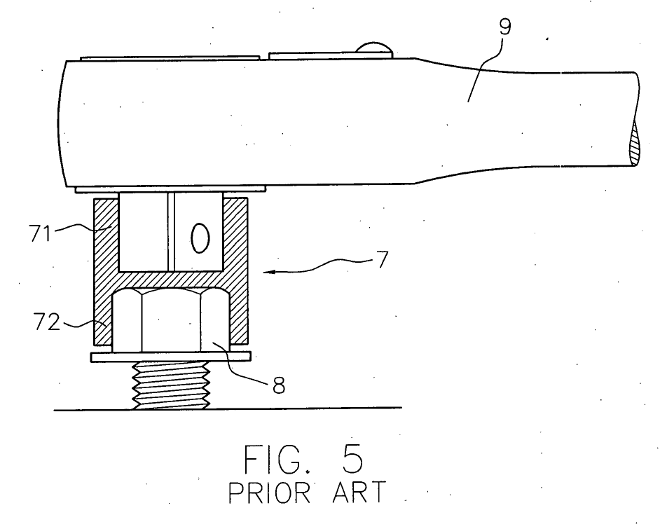

### DETAILED DESCRIPTION OF THE PREFERRED EMBODIMENT

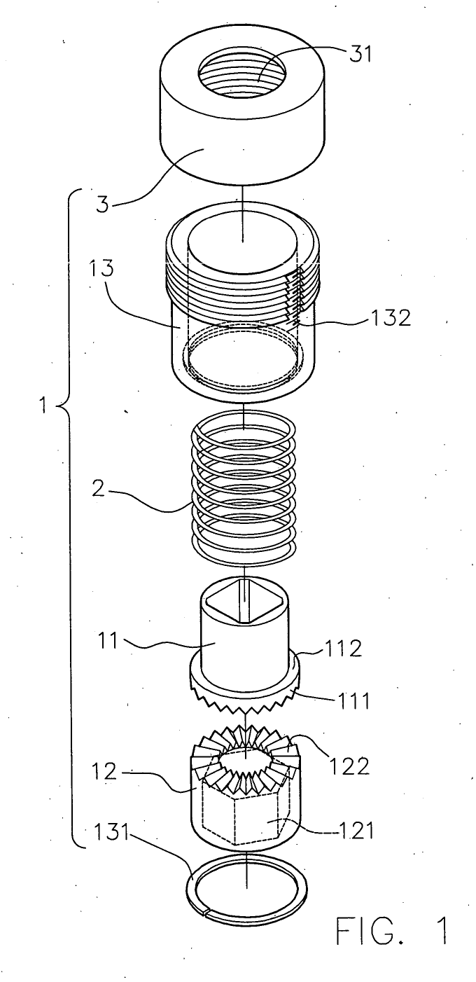

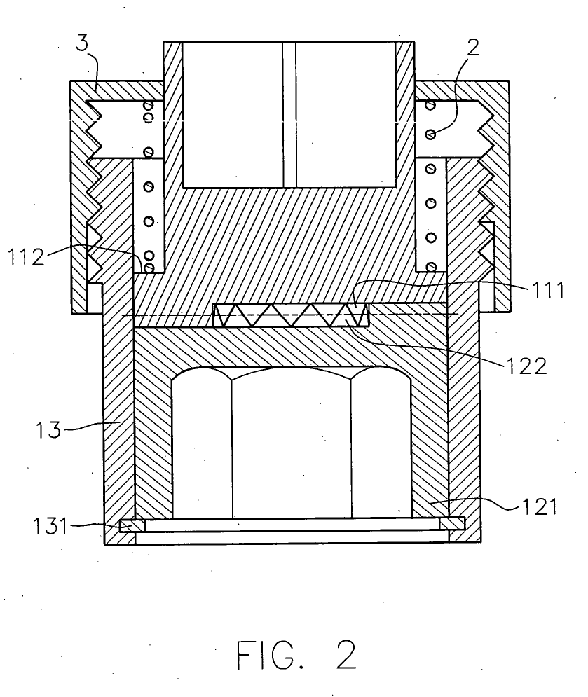

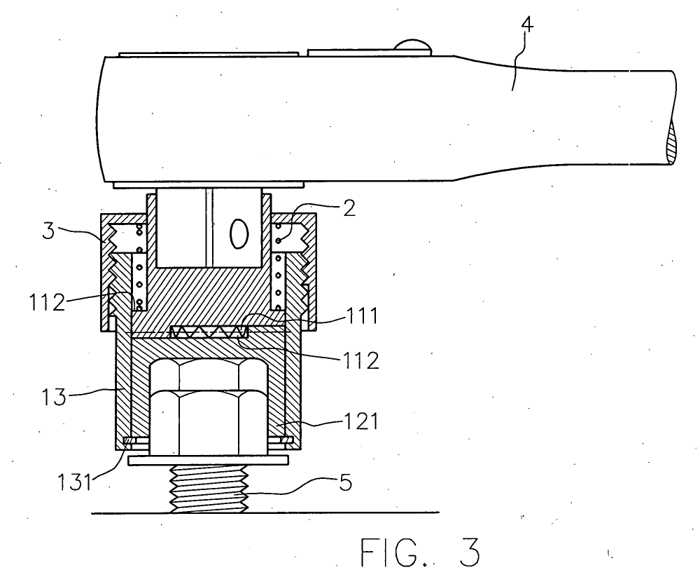

Referring to FIGS. 1 and 2, the socket assembly 1 of the present invention comprises a first part 11 having a first toothed surface 111 defined in a first end thereof and a second end of the first part 11 includes a rectangular recess so as to receive a driving head of a ratchet tool 4 as shown in FIG. 3. A second part 12 of the socket assembly 1 has a work end 121 at a first end thereof and a second toothed surface 122 is defined in a second end of the second part 12. The first and second toothed surfaces 111, 122 are engaged with each other. The work end 121 includes a recess for receiving a head of a bolt 5 as shown in FIG. 3.

A sleeve 13 is mounted to the first and second part 11, 12 and the second end of the first part 11 extends through a first open end of the sleeve 13. A stop 131 extends from an inner periphery of a second open end of the sleeve 13 and the stop 131 can be a metal O-shaped ring. The work end 121 is stopped on the stop 131. A plurality of value markings 132 are marked on an outer periphery of the sleeve 13.

A cover 3 is threadedly connected to the outer periphery of the sleeve 13 and includes a through hole 31 through which the second end of the first part 11 extends. A biasing member 2 such as a spring is mounted on the first part 11 and a first end of the biasing member 2 is rested on a flange 112 extending radially outward from the first part 11, and a second end of the biasing member 2 is in contact with an inside of the cover 3.

As shown in FIG. 3, the user may rotate the cover 3 and the biasing member 2 is then compressed to push the first part 11 toward the second part 12. The user can read the value marking 132 that is in flush with the lower end of the cover 3. The value marking 132 is the pre-set torque value of the socket assembly. The driving head of the ratchet tool 4 is connected to the first part 11 and the user rotates the ratchet tool 4 to apply a torque to the bolt 5. When the torque reaches the pre-set value of the torque, the reaction force from the bolt 5 pushes the first part 11 to compress the biasing member 2 upward so that the first toothed surface 111 slips over the second toothed surface 122, and no further torque is added to the bolt 5. In other words, the socket assembly 1 applies a pre-set torque to the bolt 5.

The values of the torque can be changed by rotating the cover 3 so as to meet different requirements.

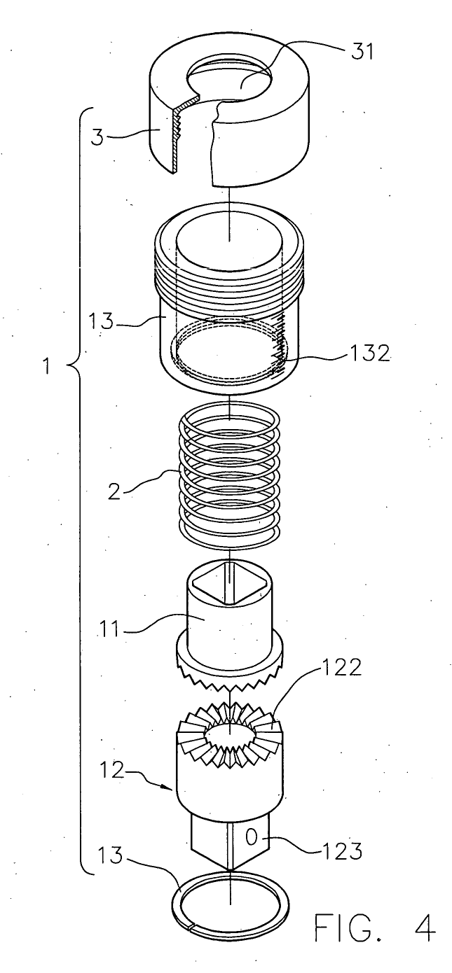

As shown in FIG. 4, another embodiment of the socket assembly 1 of the present invention includes the same components as the first embodiment in FIGS. 1 and 2, the only difference is that the work end of the second part 12 is a driving head 123 extending therefrom. The driving head 123 can be connected with another socket so as to expand the range of use of the socket assembly.

While we have shown and described the embodiment in accordance with the present invention, it should be clear to those skilled in the art that further embodiments may be made without departing from the scope of the present invention.

What is claimed is:

1. A socket assembly comprising:
a first part having a first toothed surface defined in a first end thereof and a second end of the first part adapted to be connected with a tool;
a second part having a work end at a first end thereof and a second toothed surface defined in a second end of the second part, the first and second toothed surfaces being engaged with each other;
a sleeve mounted to the first and second part and the second end of the first part extending through a first open end of the sleeve, a stop extending from an inner periphery of a second open end of the sleeve, the work end being stopped on the stop, value markings being marked on an outer periphery of the sleeve;
a cover threadedly connected to the outer periphery of the sleeve and including a through hole through which the second end of the first part extends, and
a biasing member mounted on the first part and a first end of the biasing member being rested on a flange of the first part, a second end of the biasing member being in contact with an inside of the cover.

2. The assembly as claimed in claim 1, wherein the biasing member is a spring.

3. The assembly as claimed in claim 1, wherein the stop is an O-shaped ring.

4. The assembly as claimed in claim 1, wherein the work end of the second part includes a recess defined therein.

5. The assembly as claimed in claim 1, wherein the work end of the second part includes a driving head extending therefrom.
